(19) United States
(12) Patent Application Publication
(10) Pub. No.: US 2026/0317636 A1
(43) Pub. Date: Oct. 15, 2026

(54) METHODS OF PROCESSING HYDROCARBONS IN MULTI-ZONED REACTORS

(71) Applicant: Saudi Arabian Oil Company, Dhahran (SA)

(72) Inventors: Isidoro Morales Osorio, Thuwal (SA); Khalid A. Almajnouni, Jeddah (SA); Lujain R. Alfilfil, Thuwal (SA); Mohammed Abdulrahman Hakami, Jeddah (SA)

(73) Assignee: Saudi Arabian Oil Company, Dhahran (SA)

(21) Appl. No.: 19/174,347

(22) Filed: Apr. 9, 2025

(51) Int. Cl. C10G 11/18; B01J 29/08; B01J 29/40; B01J 35/70; B01J 49/40

(52) U.S. Cl. CPC C10G 11/182; B01J 29/084; B01J 29/40; B01J 35/70; B01J 49/40; B01J 2229/42; C10G 2300/4093; C10G 2300/807; C10G 2400/20

(57) ABSTRACT

A method for processing hydrocarbons may comprise: passing a hydrocarbon feed stream into a feed inlet of a reactor; and passing the hydrocarbon product stream out of the upper reaction zone through the hydrocarbon product outlet. Another method for processing hydrocarbons may comprise: supplying a hydrocarbon feed stream to a reaction zone; supplying a fluidization gas to the reaction zone through a regeneration zone and a stripping zone; converting the hydrocarbon feed stream into a petrochemical fluid in the reaction zone in the presence of a catalyst composition; and condensing the petrochemical fluid in a condensation zone located in the single reaction unit. The catalyst composition may comprise a zeolite comprising a first portion of zeolite having a 10-membered ring pore structure, wherein the first portion of zeolite has an average crystallinity of greater than or equal to 30% and less than or equal to 90%.

### FIELD

The embodiments described herein generally relate to chemical processing and, more particularly, to methods of processing hydrocarbons.

### BACKGROUND

Light olefins, including ethylene, propylene, and butene, are basic intermediates used by a large portion of the petrochemical industry. In particular, pure streams of light olefins may be used during the production of various polymers and chemicals. Traditionally, light olefins may be produced by thermal cracking of petroleum fractions such as naphtha, kerosene, or gas oil. Light olefins could also be produced by catalytic cracking processes. As the demand for light olefins increases, there is a need for improved methods to produce light olefins.

### SUMMARY

Conventional catalytic cracking processes operate with a relatively small amount of catalyst in the reactor by utilizing lean bed or circulating fluidization regimes, such as dilute fluidized beds. Catalytic cracking processes that utilize multi-zone reactor systems, as described in embodiments herein, may lead to higher conversion of the hydrocarbons and/or higher yield of light olefins compared to traditional catalytic cracking processes. Embodiments of the present disclosure are directed to methods of processing hydrocarbons in a reactor, where the reactor includes an upper reaction zone and a lower reaction zone, and where a catalyst composition and hydrocarbons contact each other in a counter-current manner. Embodiments of the present disclosure are also directed to methods of processing hydrocarbons in a single reaction unit comprising a reaction zone, a regeneration zone, a stripping zone, and a condensation zone. It has surprisingly been discovered that these methods of processing hydrocarbons utilizing catalyst compositions comprising zeolite that is not fully crystalline, as described herein, may result in improved selectivity while still having sufficient overall conversion. For example, methods of processing hydrocarbons using a catalyst composition comprising a first portion of zeolite having a 10-membered pore ring structure, wherein the first portion of zeolite has a reduced average crystallinity (e.g., greater than or equal to 30% and less than or equal to 90%) may improve the selectivity of the catalyst composition towards light olefins when the catalyst composition is used in the processes described herein.

According to one or more embodiments disclosed herein a method for processing hydrocarbons may comprise: passing a hydrocarbon feed stream into a feed inlet of a reactor, wherein the reactor comprises: an upper reactor portion defining an upper reaction zone, the upper reactor portion comprising a catalyst inlet and a hydrocarbon product outlet, wherein the catalyst inlet and the hydrocarbon product outlet are positioned at or near the top of the upper reactor portion; and a lower reactor portion defining a lower reaction zone, the lower reactor portion comprising a feed inlet and a catalyst outlet, wherein feed inlet and the catalyst outlet are positioned at or near the bottom of the lower reactor portion, and wherein the lower reaction zone is in fluid communication with and adjacent to the upper reaction zone; and wherein: a catalyst composition moves in a generally downward direction through the upper reactor portion and the lower reactor portion and the hydrocarbon feed stream moves in a generally upward direction through the upper reactor portion and lower reactor portion such that the hydrocarbon feed stream and the catalyst composition move with a counter-current orientation; the upper reaction zone operates with a counter-current plug flow regime; the lower reaction zone operates with a dense bed fluidization regime; contacting the catalyst composition with the hydrocarbon feed stream cracks one or more components of the hydrocarbon feed stream and forms a hydrocarbon product stream, wherein the hydrocarbon product stream comprises one or more of ethylene, propylene, or butene; and the catalyst composition comprises a zeolite comprising a first portion of zeolite having a 10-membered ring pore structure, wherein the first portion of zeolite has an average crystallinity of greater than or equal to 30% and less than or equal to 90%; and passing the hydrocarbon product stream out of the upper reaction zone through the hydrocarbon product outlet.

According to one or more embodiments disclosed herein a method for processing hydrocarbons, the method may comprise: supplying a hydrocarbon feed stream to a reaction zone located in a single reaction unit; supplying a fluidization gas to the reaction zone through a regeneration zone and a stripping zone, wherein the regeneration zone and the stripping zone are located in the single reaction unit; converting the hydrocarbon feed stream into a petrochemical fluid in the reaction zone in the presence of a catalyst composition; and condensing the petrochemical fluid in a condensation zone located in the single reaction unit; wherein: the reaction zone is positioned between the condensation zone and the regeneration and stripping zones; each of the regeneration zone, the stripping zone, the reaction zone, and the condensation zone is located within the single reaction unit so that each zone is in direct contact with at least another zone within the single reaction unit; and the catalyst composition comprises a zeolite comprising a first portion of zeolite having a 10-membered ring pore structure, wherein the first portion of zeolite has an average crystallinity of greater than or equal to 30% and less than or equal to 90%.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1A schematically depicts a reactor system according to one or more embodiments of the present disclosure;

FIG. 1B schematically depicts a portion of the reactor system of FIG. 1A according to one or more embodiments of the present disclosure;

FIG. 2 schematically depicts a reactor system according to one or more embodiments of the present disclosure;

FIG. 3 graphically depicts powder x-ray diffraction (XRD) plots with relative intensity on the y-axis as a function of 2 theta in degrees on the x-axis for zeolites of the catalyst compositions disclosed herein;

FIG. 4 graphically depicts powder x-ray diffraction (XRD) plots with relative intensity on the y-axis as a function of 2 theta in degrees on the x-axis for zeolites of the catalyst compositions disclosed herein; and

FIG. 5 graphically depicts ammonia temperature programmed desorption (TPD) plots with thermal conductivity detector (TCD) signal on the y-axis as a function of temperature in degrees Celsius on the x-axis for zeolites of the catalyst compositions disclosed herein.

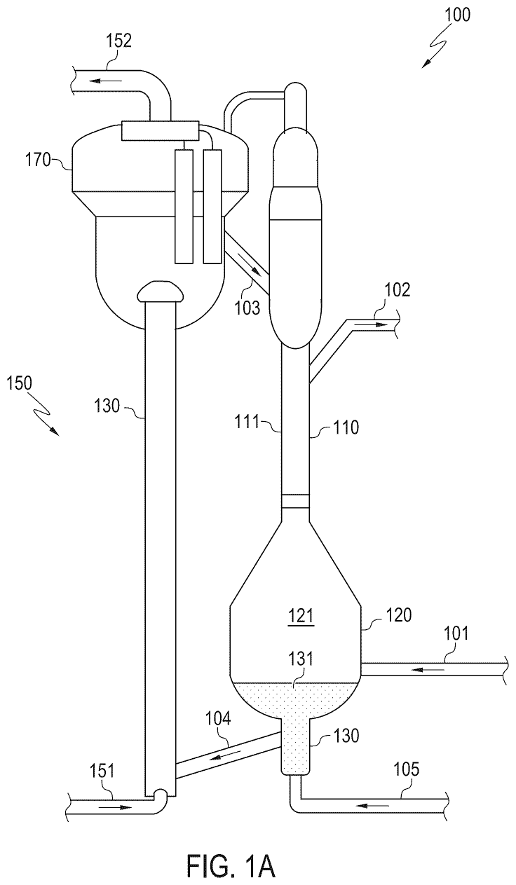

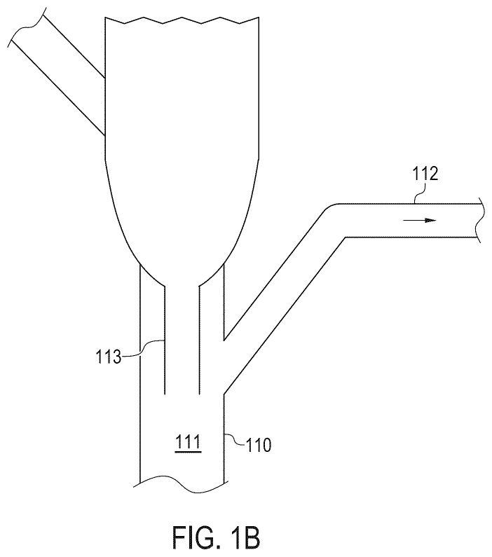

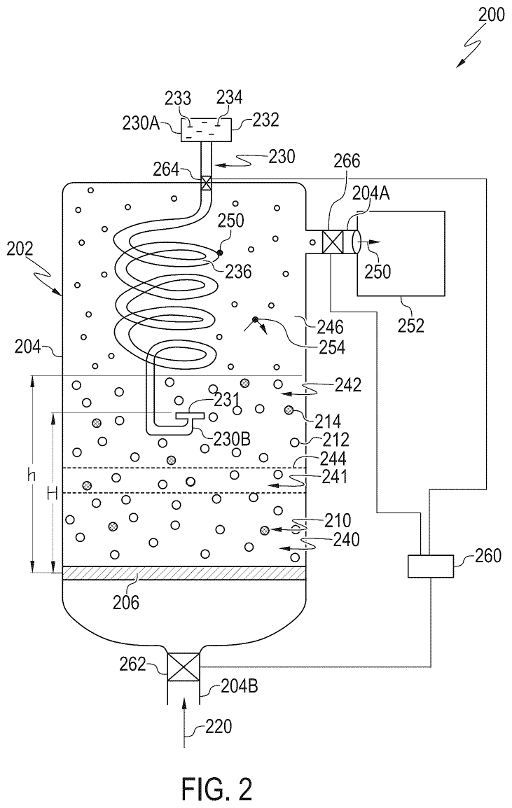

When describing the simplified schematic illustrations of FIGS. 1A, 1B, and 2, the numerous valves, temperature sensors, electronic controllers, and the like, which may be used and are well known to a person of ordinary skill in the art, are not included. Further, accompanying components that are often included in such reactor systems, such as air supplies, heat exchangers, surge tanks, and the like are also not included. However, it should be understood that these components are within the scope of the present disclosure.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. Accompanying components that are in the systems, such as bleed streams, spent catalyst discharge subsystems, and catalyst replacement sub-systems are also not shown. It should be understood that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some of which are illustrated in the accompanying drawing.

### DETAILED DESCRIPTION

One or more embodiments presently described herein are directed methods of processing hydrocarbons utilizing catalyst compositions comprising a zeolite comprising a first portion of zeolite having a 10-membered ring pore structure, wherein the first portion of zeolite has an average crystallinity of greater than or equal to 30% and less than or equal to 90%. As described herein, and particularly with respect to the Examples that follow, the catalysts described herein may result in improved selectivity while still having sufficient overall conversion.

As used throughout this disclosure, “zeolites” or “zeolite materials” generally refer to micropore-containing inorganic materials with regular intra-crystalline cavities and channels of molecular dimension, as would be understood by those skilled in the art. Zeolites generally comprise a crystalline structure, as opposed to an amorphous structure. The microporous structure of zeolites may render large surface areas and desirable size-/shape-selectivity, which may be advantageous for catalysis. Accordingly, zeolites may be utilized in many petrochemical industrial applications, such as, for instance, reactions that convert hydrocarbons or other reactants from feed chemicals to product chemicals by cracking.

According to one or more embodiments, the zeolites may be aluminosilicates, meaning that they have a crystalline structure that include silica and alumina. The average crystallinity of the zeolite can affect the properties of the zeolite when the zeolite is used in a chemical reaction. As demonstrated herein, for example, a zeolite having a 10-membered ring pore structure and a relatively low average crystallinity may surprisingly be more selective towards the production of light olefins when used as a catalyst to process a hydrocarbon feed stream and/or have a higher overall hydrocarbon conversion than a zeolite with a relatively higher average crystallinity. As used herein, the terms “hydrocarbon feedstock” and “hydrocarbon feed stream” may be used interchangeably.

In embodiments, the first portion of zeolite having a 10-membered ring pore structure may have an average crystallinity of less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, greater than or equal to 30%, greater than or equal to 35%, greater than or equal to 40%, or from any combination of one or more of these ranges. For example, in embodiments, the first portion of zeolite having a 10-membered ring pore structure may have an average crystallinity of greater than or equal to 30% and less than or equal to 60%. It should be understood that catalyst compositions that include zeolite comprising a first portion of zeolite need not comprise additional portions of zeolite in all embodiments. That is, in some embodiments, the zeolite may consist of the first portion of zeolite.

As described herein, zeolites may be characterized by “average crystallinity.” In general, the average crystallinity is a percentage value that is relative to a fully crystalline zeolite of the same type. For example, a zeolite with an average crystallinity of 75% has 75% of the crystallinity of that same zeolite in fully crystalline form. The average crystallinity of the first or second portions of zeolite may be determined using powder x-ray diffraction to measure a peak height or area, or full width at half maximum of the first or second portions of zeolite relative to a fully crystalline control of a parent zeolite present in the first or second portions of zeolite. The peak heights or areas, or full widths at half maximum may be compared between the fully crystalline sample and the tested sample zeolite to attain the average crystallinity. In embodiments, the average crystallinity of the first or second portions of zeolite are determined using powder x-ray diffraction to measure the area under a characteristic peak of zeolite material and normalized to an area under a characteristic peak of a fully crystalline reference zeolite material. The methods used to determine average crystallinity are further detailed in “Influence of aluminum content, crystallinity and crystallite size of zeolite Pd/H-ZSM-5 on the catalytic performance in the dehydroalkylation of toluene with ethane” Microporous and Mesoporous Materials 109 (2008) 278-286, and “On the Synthesis of ZSM-5 Directly from Kaolin Bangka with Aging Time” Materials Science and Engineering 588 (2019), 012039, both of which are incorporated by reference in their entireties. As described in “Influence of aluminum content, crystallinity and crystallite size of zeolite Pd/H-ZSM-5 on the catalytic performance in the dehydroalkylation of toluene with ethane” Microporous and Mesoporous Materials 109 (2008) 278-286, and “On the Synthesis of ZSM-5 Directly from Kaolin Bangka with Aging Time” Materials Science and Engineering 588 (2019), 012039, the characteristic peaks of the zeolite (e.g. ZSM-5) are identified in an XRD diffractogram. The area under the characteristic peak of the zeolite is calculated and normalized to the integrated area of the fully crystalline reference sample to determine the average crystallinity of each portion of the zeolite in the catalyst composition described herein. In embodiments, the average crystallinity of the first or second portions of zeolite are determined using powder x-ray diffraction to measure the area under a characteristic peak of zeolite material and normalized to an area under a characteristic peak of a fully crystalline reference zeolite material.

Without intending to be bound by any particular theory, it is believed that by utilizing a catalyst composition comprising a first portion of zeolite having a 10-membered ring pore structure, wherein the first portion of zeolite has a reduced average crystallinity, the partially crystalline material may have a modified acidity strength and/or acidity density, which may enhance the conversion of a hydrocarbon feed stream and/or selectivity for producing olefins. Further, it is believed that first portion of zeolite having a reduced average crystallinity may include a combination both crystalline and amorphous structures, which may exhibit a combination of their properties. In the crystalline structures, acidic sites may be stronger as they may be associated with tetrahedral framework of a negatively charged [AlO₄]⁻ unit that is counterbalanced by H⁺ cations, which may result in the crystalline structures being useful for the selective cracking of smaller molecules. In contrast, amorphous structures have a disordered distribution, which may lead to a broader range of acidity, a greater proportion of weaker acidic sites, or both, each of which may provide flexibility in terms of adsorption and diffusion for more effective cracking of larger and more complex molecules. Therefore, it is believed that a synergy between the two phases (crystalline and amorphous) can be used to tune the overall catalytic activity and improve conversion rate and product distribution. Further, it is believed that by utilizing the first portion of zeolite, as described herein, a hydrogen transfer reaction may be reduced, which leads to an increase in the light olefins yield.

In embodiments, the zeolite may comprise from 10 wt. % to 60 wt. % of the first portion of zeolite having a 10-membered ring pore structure, based on a total weight of the zeolite. In one or more embodiments, the zeolite may comprise the first portion of zeolite in an amount from 10 wt. % to 15 wt. %, from 15 wt. % to 20 wt. %, from 20 wt. % to 25 wt. %, from 25 wt. % to 30 wt. %, from 35 wt. % to 40 wt. %, from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. %, from 70 wt. % to 75 wt. %, from 75 wt. % to 80 wt. %, from 80 wt. % to 85 wt. %, from 85 wt. % to 90 wt. %, from 90 wt. % to 95 wt. %, from 95 wt. % to 100 wt. %, or from any combination of one or more of these ranges.

In embodiments, the zeolite may further comprise a second portion of zeolite having a 12-membered ring pore structure. In embodiments, the second portion of zeolite having a 12-membered ring pore structure may have an average crystallinity of greater than or equal to 80%, greater than or equal to 90%, greater than or equal to 95%, or greater than or equal to 99%.

In embodiments, the zeolite may comprise from 0 wt. % to 90 wt. % of the second portion of zeolite having a 12-membered ring pore structure, based on a total weight of the zeolite. In one or more embodiments, the zeolite may comprise the second portion of zeolite in an amount from 10 wt. % to 15 wt. %, from 15 wt. % to 20 wt. %, from 20 wt. % to 25 wt. %, from 25 wt. % to 30 wt. %, from 35 wt. % to 40 wt. %, from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. %, from 70 wt. % to 75 wt. %, from 75 wt. % to 80 wt. %, from 80 wt. % to 85 wt. %, from 85 wt. % to 90 wt. %, or from any combination of one or more of these ranges.

Without intending to be bound by any particular theory, it is believed that by utilizing a catalyst composition comprising a second portion of zeolite having a 12-membered ring pore structure, the second portion of zeolite may preferentially crack bulkier molecules present in the hydrocarbon feed stream.

The zeolite may comprise 99 wt. % or more of the combination of the first portion of zeolite and the second portion of the zeolite.

In embodiments, a ratio of the first portion of zeolite to the second portion of zeolite may be from 1:10 to 10:1. For example, in embodiments, a ratio of the first portion of zeolite to the second portion of zeolite may be from 1:10 to 1:9, from 1:9 to 1:8, from 1:8 to 1:7, from 1:7 to 1:6, from 1:6 to 1:5, from 1:5 to 1:4, from 1:4 to 1:3, from 1:3 to 1:2, from 1:2 to 1:1, from 1:1 to 2:1, from 2:1 to 3:1, from 3:1 to 4:1, from 4:1 to 5:1, from 5:1 to 6:1, from 6:1 to 7:1, from 7:1 to 8:1, from 8:1 to 9:1, from 9:1 to 10:1, or from any combination of one or more of these ranges.

The first portion of zeolite may comprise any framework type of zeolite that has a 10-membered ring pore structure and an appropriate relative crystallinity, as described hereinabove. In one or more embodiments, the first portion of zeolite may comprise a ZSM-5 zeolite. As used throughout this disclosure, “ZSM-5” generally refers to zeolites having an MFI framework type according to the IZA zeolite nomenclature and consisting majorly of silica and alumina, as is understood by those skilled in the art. ZSM-5 refers to “Zeolite Socony Mobil-5” and is a pentasil family zeolite that can be represented by the chemical formula NaₙAlₙSi₉₆-nO₁₉₂·16H₂O, where 0<n<27.

The second portion of zeolite may comprise any framework type of zeolite that has a 12-membered ring pore structure and an appropriate relative crystallinity, as described hereinabove. In one or more embodiments, the second portion of zeolite may comprise a zeolite Y. As used throughout this disclosure, “zeolite Y” and “USY” refer to a zeolite having a FAU framework type according to the IZA zeolite nomenclature and consisting majorly of silica and alumina, as would be understood by one skilled in the art.

As described hereinabove, in one or more embodiments the catalyst composition may comprise from 5 wt. % to 70 wt. % of zeolite, based on a total weight of the catalyst composition. For example, the catalyst composition may include from 5 wt. % to 10 wt. % of zeolite, from 10 wt. % to 15 wt. % of zeolite, from 15 wt. % to 20 wt. % of zeolite, from 20 wt. % to 25 wt. % of zeolite, from 25 wt. % to 30 wt. % of zeolite, from 30 wt. % to 35 wt. % of zeolite, from 35 wt. % to 40 wt. % of zeolite, from 40 wt. % to 45 wt. % of zeolite, from 45 wt. % to 50 wt. % of zeolite, from 50 wt. % to 55 wt. % of zeolite, from 55 wt. % to 60 wt. % of zeolite, from 60 wt. % to 65 wt. % of zeolite, from 65 wt. % to 70 wt. % of the zeolite, or from any combination of one or more of these ranges.

In one or more embodiments, the catalyst composition may comprise one or more binder materials, such as alumina-containing compounds or silica-containing compounds (including compounds containing alumina and silica). As used throughout this disclosure, “binder materials” refer to materials that may serve to “glue” or otherwise hold components of the catalyst composition together in the microsphere. It may improve the attrition resistance of the catalyst particle. For example, the binder material may comprise alumina (such as amorphous alumina), silica-alumina (such as amorphous silica-alumina), or silica (such as amorphous silica). According to one or more embodiments, the binder material may comprise pseudoboehmite. As used in this disclosure, “pseudoboehmite” refers to an aluminum-containing compound with the chemical composition AIO(OH) consisting of crystalline boehmite. Suitable pseudoboehmite includes CATAPAL® aluminas, commercially available from Sasol Limited of Johannesburg, South Africa. Boehmite refers to aluminum oxide hydroxide as well, but pseudoboehmite generally has a greater amount of water than boehmite. The binder material, such as pseudoboehmite, may be peptized with an acid, such as a mono-protic acid, such as nitric acid (“HNO₃”) or hydrochloric acid (“HCl”).

According to one or more embodiments, the catalyst composition may comprise from 10 wt. % to 75 wt. % of binder. For example, the catalyst composition may comprise from 10 wt. % to 15 wt. % of binder, from 15 wt. % to 20 wt. % of binder, from 20 wt. % to 25 wt. % of binder, from 25 wt. % to 30 wt. % of binder, from 30 wt. % to 35 wt. % of binder, from 35 wt. % to 40 wt. % of binder, from 40 wt. % to 45 wt. % of binder, from 45 wt. % to 50 wt. % of binder, from 50 wt. % to 55 wt. % of binder, from 55 wt. % to 60 wt. % of binder, from 60 wt. % to 65 wt. % of binder, from 65 wt. % to 70 wt. % of binder, from 70 wt. % to 75 wt. % of binder, or from any combination of one or more of these ranges. It should be understood that, in one or more embodiments, the catalyst composition may include any single disclosed binder material in an amount of the discloses wt. % ranges. In additional embodiments, the catalyst composition may include any two or more binder materials in combination in any amount of the disclosed wt. % ranges.

In one or more embodiments, the catalyst composition may comprise, consist essentially of, or consist of from 10 wt. % to 75 wt. % of binder, and from 5 wt. % to 70 wt. % of zeolite. In one or more embodiments, the catalyst composition may comprise, consist essentially of, or consist of from 0 wt. % to 50 wt. % of matrix material, from 10 wt. % to 75 wt. % of binder, and from 5 wt. % to 70 wt. % of zeolite.

In one or more embodiments, the binder may comprise a clay material such as kaolin. Without being bound by theory, it is believed that the binder materials of the catalyst composition may serve both physical and catalytic functions. Physical functions include providing particle density, acting as a heat transfer medium

In one or more embodiments, the binder material comprises kaolin. As used in this disclosure, “kaolin” refers to a clay material that has a relatively large amount (such as at least about 50 wt. %, at least 60 wt. %, at least 70 wt. %, at least 80 wt. %, at least 90 wt. %, or even at least 95 wt. %) of kaolinite, which can be represented by the chemical formula Al₂Si₂O₅(OH)₄. Kaolin is sometimes referred to as “china clay.” In additional embodiments, the matrix material may comprise other clay materials.

Additives, such as matrix materials may be added to the catalyst composition to achieve specific properties. Without being bound by theory, it is believed that the matrix materials of the catalyst composition may serve both physical and catalytic functions. The matrix can also affect catalyst selectivity, product quality and resistance to poisons. The matrix materials may tend to exert its strongest influence on overall catalytic properties for those reactions, which directly involve relatively large molecules. Matrix materials can be amorphous alumina-silicate or any metals trap components that are known in the open literatures. In one or more embodiments, the catalyst composition may further comprise matrix materials. In one or more embodiments, the catalyst composition may comprise from 0 wt. % to 40 wt % matrix materials. For example, the catalyst composition may comprise from 0 wt. % to 5 wt. % of matrix materials, 5 wt. % to 10 wt. % of matrix materials, 10 wt. % to 15 wt. % of matrix materials, 15 wt. % to 20 wt. % of matrix materials, 20 wt. % to 25 wt. % of matrix materials, 25 wt. % to 30 wt. % of matrix materials, 30 wt. % to 35 wt. % of matrix materials, 35 wt. % to 40 wt. % of matrix materials, or from any combination of one or more of these ranges. It should be understood that, in one or more embodiments, the catalyst composition may include any single disclosed matrix material in an amount of the discloses wt. % ranges.

Metal carbides (MC) in the formulation may act as diluents that increase the density of the catalyst particle and improve its thermal conductivity. Better thermal conductivities aid in stabilizing the temperature profile of the catalyst bed and reduce cold/hot spots. In one or more embodiments, the catalyst composition may further comprise silicon carbide particles. In one or more embodiments, the catalyst composition may further comprise from 1 wt. % to 40 wt. % of silicon carbide particles. For example, the catalyst composition may comprise from 1 wt. % to 5 wt. %, from 5 wt. % to 10 wt. % of silicon carbide particles, from 10 wt. % to 15 wt. % of silicon carbide particles, from 15 wt. % to 20 wt. % of silicon carbide particles, from 20 wt. % to 25 wt. % of silicon carbide particles, from 25 wt. % to 30 wt. % of silicon carbide particles, from 30 wt. % to 35 wt. % of silicon carbide particles, from 35 wt. % to 40 wt. % of silicon carbide particles, or from any combination of one or more of these ranges. In one or more embodiments, the silicon carbide particles may have an average particle size of from 50 nm to 900 nm. For example the silicon carbide particles may have an average particle size of from 50 nm to 100 nm, from 100 nm to 150 nm, from 150 nm to 200 nm, from 200 nm to 250 nm, from 250 nm to 300 nm, from 300 nm to 350 nm, from 350 nm to 400 nm, from 400 nm to 450 nm, from 450 nm to 500 nm, from 500 nm to 550 nm, from 550 nm to 600 nm, from 600 nm to 650 nm, from 650 nm to 700 nm, from 700 nm to 750 nm, from 750 nm to 800 nm, from 800 nm to 850 nm, from 850 nm to 900 nm, or from any combination of one or more of these ranges.

In one or more embodiments, the catalyst composition may be formed as particles. The particles may be shaped particles, such as spheres, or may be inconsistent in shape or otherwise globular in shape. The size of a particle refers to the maximum length of a particle from one side to another, measured along the longest distance of the particle. For example, a spherically shaped particle has a size equal to its diameter, or a rectangular prism shaped particle has a maximum length equal to the hypotenuse stretching from opposite corners. The particles of the catalyst composition may have an average diameter ranging from 20 microns to 200 microns, such as from 20 microns to 30 microns, from 30 microns to 40 microns, from 40 microns to 50 microns, from 50 microns to 60 microns, from 60 microns to 70 microns, from 70 microns to 80 microns, from 80 microns to 90 microns, from 90 microns to 100 microns, or from any combination of one or more of these ranges. Average particle size can be measured using laser diffraction analysis.

In one or more embodiments, the first and second portions of zeolite may be present on the same particle. In other embodiments, the first and second portions of zeolite may each be present on different particles.

In one or more embodiments, the catalyst composition of the present disclosure may be used to process hydrocarbons. Suitable systems and methods that may utilize the catalyst compositions of the present disclosure may include those described in U.S. Pat. No. 11,446,625, U.S. Patent Publication No. 2022/0033714, and U.S. Pat. No. 11,965,133, the entireties of each which are incorporated by reference herein. For example, methods for processing hydrocarbons may use the catalyst compositions described herein in the FCC systems depicted in any one of FIGS. 2 and 4-8 of U.S. Pat. No. 11,446,625, any one of FIGS. 1-2 of U.S. Patent Publication No. 2022/0033714, and/or any one of FIGS. 1-4 of U.S. Pat. No. 11,965,133.

In embodiments, a method of processing hydrocarbons may comprise passing a hydrocarbon feed stream into a reactor. The hydrocarbon feed stream may generally comprise a hydrocarbon material. In embodiments, the hydrocarbon material of the hydrocarbon feed stream may be crude oil. As used in this disclosure, the term “crude oil” is to be understood to mean a mixture of petroleum liquids, gases, or combinations of liquids and gases, including some embodiments impurities such as sulfur-containing compounds, nitrogen-containing compounds and metal compounds that has not undergone significant separation or reaction processes. Crude oils are distinguished from fractions of crude oil. In certain embodiments, the crude oil feedstock may be a minimally treated light crude oil to provide a crude oil feedstock having total metals (Ni+V) content of less than 30 parts per million by weight (ppmw) and Conradson carbon residue of less than 10 wt %. Such minimally treated materials may be considered crude oils as described herein.

While the present description and examples may specify crude oil as the hydrocarbon material of the hydrocarbon feed stream, it should be understood that the systems and methods may be applicable for the conversion of a wide variety of hydrocarbon materials, which may be present in the hydrocarbon feed stream, including, but not limited to, crude oil, vacuum residue, tar sands, bitumen, atmospheric residue, vacuum gas oils, demetallized oils, naphtha streams, other hydrocarbon streams, or combinations of these materials. The hydrocarbon feed stream may include one or more non-hydrocarbon constituents, such as one or more heavy metals, sulphur compounds, nitrogen compounds, inorganic components, or other non-hydrocarbon compounds. If the hydrocarbon feed stream is crude oil, it may have an American Petroleum Institute (API) gravity of from 22 degrees to 40 degrees. For example, the hydrocarbon feed stream utilized may be an Arab heavy crude oil. (API gravity of approximately 28°), Arab medium (API gravity of approximately 30°), Arab light (API gravity of approximately 33°), or Arab extra light (API gravity of approximately 39°). It should be understood that, as used in this disclosure, a “hydrocarbon feed stream” may refer to a raw hydrocarbon material which has not been previously treated, separated, or otherwise refined (such as crude oil) or may refer to a hydrocarbon material which has undergone some degree of processing, such as treatment, separation, reaction, purifying, or other operation, prior to being introduced to the reactor.

In general, the contents of the hydrocarbon feed stream may include a relatively wide variety of chemical species based on boiling point. For example, the hydrocarbon feed stream may have composition such that the difference between the 5 wt. % boiling point and the 95 wt. % boiling point of the hydrocarbon feed stream is at least 100° C., at least 200° C., at least 300° C., at least 400° C., at least 500° C., or even at least 600° C.

Referring now to FIG. 1A, which corresponds to FIG. 1 of U.S. Patent Publication No. 2022/0033714, a reactor 100 for producing light olefins is schematically depicted. The reactor comprises an upper reactor portion 110, a lower reactor portion 120, and a steam stripping portion 130. The upper reactor portion 110 may comprise an upper reaction zone 111. The lower reactor portion 120 may define a lower reaction zone 121. A hydrocarbon feed stream 101 may enter the lower reaction zone 121 through one or more feed inlets located in the lower reactor portion 120. The one or more feed inlets may be positioned at or near the bottom of the lower reactor portion 120. Additionally, the lower reactor portion 120 may comprise one or more catalyst outlets positioned at or near the bottom of the lower reactor portion 120. As described herein, at or near the bottom of the lower reactor portion 120 corresponds to positions in the bottom 10%, bottom 5%, or even bottom 1% of the height of the lower reactor portion 120.

The upper reactor portion 110 defines an upper reaction zone 111. The hydrocarbon feed stream 101 may move through the lower reaction zone 121 and into the upper reaction zone 111. The upper reactor portion 110 and the lower reactor portion 120 may be in fluid communication with each other. In one or more embodiments, the upper reactor portion 110 and the lower reactor portion may be adjacent to each other, with no intervening components or reactor portions. In one or more embodiments, the hydrocarbon feed stream 101 may pass directly from the lower reactor portion 120 to the upper reactor portion 110.

The system described in FIG. 1A may be used in various methods, further described herein. In embodiments, a method for processing hydrocarbons may comprise passing a hydrocarbon feed stream into a feed inlet of a reactor, wherein the reactor comprises: an upper reactor portion defining an upper reaction zone, the upper reactor portion comprising a catalyst inlet and a hydrocarbon product outlet, wherein the catalyst inlet and the hydrocarbon product outlet are positioned at or near the top of the upper reactor portion; and a lower reactor portion defining a lower reaction zone, the lower reactor portion comprising a feed inlet and a catalyst outlet, wherein feed inlet and the catalyst outlet are positioned at or near the bottom of the lower reactor portion, and wherein the lower reaction zone is in fluid communication with and adjacent to the upper reaction zone. A catalyst composition (which may include any of the catalyst compositions described herein) may move in a generally downward direction through the upper reactor portion and the lower reactor portion and the hydrocarbon feed stream may move in a generally upward direction through the upper reactor portion and lower reactor portion such that the hydrocarbon feed stream and the catalyst composition move with a counter-current orientation. In embodiments, contacting the catalyst composition with the hydrocarbon feed stream may crack one or more components of the hydrocarbon feed stream and form a hydrocarbon product stream. The hydrocarbon product stream may comprise one or more of ethylene, propylene, or butene

Referring now to FIG. 1B, which corresponds to FIG. 2 of U.S. Patent Publication No. 2022/0033714, a cross-sectional view of the upper reactor portion 110, as depicted in FIG. 1A, is shown. The upper reactor portion 110 includes a hydrocarbon product outlet 112 and a catalyst inlet 113, which may be positioned at or near the top of the upper reactor portion 110. As described herein, at or near the top of the upper reactor portion 110 corresponds to positions in the top 10%, top 5%, or even top 1% of the height of the upper reactor portion 110. Catalyst may enter the upper reactor portion 110 through catalyst inlet 113. As shown in FIG. 1B, the catalyst inlet 113 may extend into the upper reactor portion 110 so the catalyst enters the upper reaction zone 111 below the hydrocarbon product outlet 112. As shown in FIG. 1B, the hydrocarbon product outlet 112 is defined by an opening in the upper reactor portion 110, and the hydrocarbon product outlet 112 does not extend into upper reaction zone 111. Thus, catalyst may enter the upper reaction zone below the hydrocarbon outlet 112. Without wishing to be bound by theory, it is believed that introducing the catalyst below the hydrocarbon product outlet 112 may reduce the amount of catalyst entrained in the hydrocarbon product exiting the reactor 100.

As shown in FIG. 1A, the lower reactor portion 120 may have a larger cross-sectional area than the upper reactor portion 110. In one or more embodiments, the lower reactor portion 120 may have a substantially similar cross-sectional area to the upper reactor portion 110.

In one or more embodiments, the upper reaction zone 111 may operate in a counter-current plug flow regime. In one or more embodiments, the hydrocarbon feed 101 may exhibit plug flow as it moves up through the upper reaction zone 111. Likewise, the catalyst may exhibit plug flow as it moves down through the upper reaction zone 111. Since the flow of catalyst is opposed to the flow of the hydrocarbon feed, the flows are counter-current and the upper reaction zone 111 may operate in a counter-current plug flow regime.

In one or more embodiments, the catalyst-to-oil ratio in the upper reaction zone 111 may be from 5 to 100. For example, the catalyst-to-oil ratio in the upper reaction zone 111 may be from 5 to 100, from 10 to 100, from 20 to 100, from 30 to 100, from 40 to 100, from 50 to 100, from 60 to 100, from 70 to 100, from 80 to 100, or even from 90 to 100. In further examples, the catalyst-to-oil ratio in the upper reaction zone 111 may be from 5 to 90, from 5 to 80, from 5 to 70, from 5 to 60, from 5 to 50, from 5 to 40, from 5 to 30, from 5 to 20, or even from 5 to 10. Without wishing to be bound by theory, it is believed that there is less constraint on catalyst-to-oil ratios suitable for use in the upper reaction zone 111 because the catalyst may flow through the upper reaction zone 111 by gravity instead of being transported through the reactor by the flow of hydrocarbons. Additionally, a high catalyst-to-oil ratio indicates a large amount of catalyst within the upper reaction zone 111, which is believed to lead to increased conversion of the hydrocarbon feed to light olefins.

The catalyst may move through the upper reaction zone 111 and into the lower reaction zone 121. In one or more embodiments, the catalyst may pass directly from the upper reaction zone 111 to the lower reaction zone 121. The lower reaction zone 121 may operate in a dense bed fluidization regime. In one or more embodiments, the catalyst may pass from the upper reaction zone 111 to the lower reaction zone 121 and form a dense fluidized bed in the lower reaction zone 121. As described herein, a “dense bed fluidization regime” refers to a fluidization regimes in which the fluidized bed has a clearly defined upper limit or surface to the dense bed. For example, dense bed fluidization regimes include the smooth fluidization, bubbling fluidization, slugging fluidization, and turbulent fluidization regimes. In a dense fluidized bed, the particle entrainment rate may be low, but may increase as the velocity of the gas flowing through the bed increases.

In one or more embodiments, the weight hourly space velocity (WHSV) of the lower reaction zone 121 may be from 1 to 200 hr⁻¹. For example, the WHSV of the lower reaction zone 121 may be from 1 to 200 hr⁻¹, from 1 to 175 hr⁻¹, from 1 to 150 hr⁻¹, from 1 to 125 hr¹, from 1 to 100 hr⁻¹, from 1 to 75 hr⁻¹, from 1 to 50 hr⁻¹, or even from 1 to 25 hr⁻¹. In further examples, the WHSV of the lower reaction zone 121 may be from 25 to 200 hr⁻¹, from 50 to 200 hr⁻¹, from 75 to 200 hr⁻¹, from 100 to 200 hr⁻¹, from 125 to 200 hr⁻¹, from 150 to 200 hr⁻¹, or even from 175 to 200 hr⁻¹. WHSV may be used to describe the amount of catalyst in the dense bed of the lower reaction zone 121. Without wishing to be bound by theory, it is believed that a dense bed allows a large amount of catalyst to be present in the lower reaction zone, which may increase the yield of light olefins.

As the hydrocarbon feed stream 101 and the catalyst move through the reactor 100, the hydrocarbon feed stream 101 may have an upward superficial velocity through a horizontal cross-section of the reactor 100, and the catalyst may have a downward superficial velocity through a horizontal cross-section of the reactor 100. As described herein, “superficial velocity” refers to the velocity at which an individual phase flows through a given cross-sectional area. The bulk flow of a phase is used to determine superficial velocity of that phase; thus, individual particles or molecules within a phase may move in a direction different from, or even opposite to, the bulk flow of a phase without affecting the direction of the superficial velocity of that phase.

For example, the hydrocarbon feed stream 101 flows from the feed inlet in the lower reactor portion 120 to the hydrocarbon product outlet 112 in the upper reactor portion 110. Thus, the bulk flow of hydrocarbon feed stream 101 moving through a horizontal cross-section of the reactor 100 is in an upward direction, resulting in an upward superficial velocity. Likewise, the catalyst flows from the catalyst inlet 113 to the catalyst outlet in the steam stripping portion 130 of the reactor 100, and the bulk flow of the catalyst moving through a horizontal cross-section of the reactor 100 is in a downward direction, resulting in a downward superficial velocity. In one or more embodiments, the upward superficial velocity of the hydrocarbon feed stream 101 and the downward superficial velocity of the catalyst results in a counter-current flow pattern between the hydrocarbon feed stream 101 and the catalyst. Thus, in one or more embodiments, the hydrocarbon feed stream 101 and catalyst move with a counter-current orientation.

Without wishing to be bound by theory, it is believed that contacting the hydrocarbon feed stream 101 and the catalyst in a counter-current manner may prevent back-mixing of catalyst that may occur in in traditional riser reactors and may promote undesired side reactions that negatively affect the production of light olefins. Additionally, it is believed that contacting the hydrocarbon feed stream 301 and the catalyst in a counter-current manner may prevent core-annular flow through the reactor where the catalyst has high concentration near the reactor walls and a low concentration toward the center of the reactor where a majority of the hydrocarbon flow occurs. Generally, core-annular flow reduces the amount of contact between the catalyst and the hydrocarbon, and thus, may reduce the conversion of hydrocarbon feed to light olefins.

Without wishing to be bound by theory, it is also believed that counter-current flow may also result in increased yield of olefins by allowing the more reactive chemicals in the hydrocarbon feed to contact less active catalyst, and less active catalyst to contact more reactive chemicals in the hydrocarbon feed. Generally, the catalyst in the lower reaction zone 121 has already contacted hydrocarbons in the upper reaction zone 111. Thus, the catalyst in the lower reaction zone 121 is usually partially spent and has a lower activity than the catalyst in the upper reaction zone 111. Contacting the hydrocarbon feed with a large amount of less active catalyst in the lower reaction zone 121 may allow the more reactive chemicals in the hydrocarbon feed to crack in the lower reaction zone 121 while contacting the less active catalyst. This in turn allows the more active catalyst in the upper reaction zone 111 to crack the less reactive chemicals in the hydrocarbon feed, increasing the yield of light olefins produced from the hydrocarbon feed.

In one or more embodiments, the superficial velocity of the hydrocarbon feed stream 101 moving through the upper reactor portion 111 is 3.0 m/s or less. For example, the superficial velocity of the hydrocarbon feed stream through the upper reactor portion 311 may be 3.0 m/s or less, 2.0 m/s or less, 1.0 m/s or less, 0.9 m/s or less, 0.8 m/s or less, 0.7 m/s or less, 0.6 m/s or less, 0.5 m/s or less, or even 0.4 m/s or less. Without wishing to be bound by theory, it is believed that a hydrocarbon feed stream superficial velocity below 3.0 m/s within the upper reactor portion 311 may result in increased contact between the catalyst and the hydrocarbons, which may in turn lead to increased conversion of the hydrocarbon feed to light olefins. To keep the superficial velocity of the hydrocarbon feed stream 301 within the desired range, the residence time of the hydrocarbons within the reactor 100 may be controlled by adjusting the height of the upper reactor portion 110 and the height of the lower reactor portion 120.

In one or more embodiments, the residence time of the hydrocarbon feed stream 101 within the reactor 300 is from 0.1 to 10 seconds. For example, the residence time of the hydrocarbon feed stream 101 within reactor 100 may be from 0.1 to 10 seconds, from 0.5 to 10 seconds, from 1 to 10 seconds, from 2 to 10 seconds, from 3 to 10 seconds, from 4 to 10 seconds, from 5 to 10 seconds, from 6 to 10 seconds, from 7 to 10 seconds, from 8 to 10 seconds, or even from 9 to 10 seconds. In further examples, the residence time of the hydrocarbon feed stream 101 in the reactor 100 may be from 0.1 to 9 seconds, from 0.1 to 8 seconds, from 0.1 to 7 seconds, from 0.1 to 6 seconds, from 0.1 to 5 seconds, from 0.1 to 4 seconds, from 0.1 to 3 seconds, from 0.1 to 2 seconds, or even from 0.1 to 1 second.

As the hydrocarbon feed stream 101 contacts the catalyst, at least a portion of the hydrocarbon feed stream 101 may be cracked to form a hydrocarbon product. In one or more embodiments, the temperature within the reactor 100 may be from 420° C. to 750° C. to facilitate the cracking of hydrocarbon feed stream 101. For example, the temperature within the reactor 300 may be from 460° C. to 750° C., from 500° C. to 750° C., from 540° C. to 750° C., from 580° C. to 750° C., from 620° C. to 750° C., from 660° C. to 750° C., or even from 700° C. to 750° C. In further examples, the temperature within the reactor 100 may be from 420° C. to 710° C., from 420° C. to 670° C., from 420° C. to 630° C., from 420° C. to 590° C., from 420° C. to 550° C., or even from 420° C. to 510° C. In yet further embodiments, the temperature within the reactor 100 may be from 440° C. to 720° C., or from 480° C. to 680° C.

In one or more embodiments, the hydrocarbon product may comprise light olefins and other reactions products. For example, the hydrocarbon product may comprise ethylene, propylene, butene, or combinations of these in addition to the other reactions products. In one or more embodiments, the other reaction products may comprise dry gas, aromatics, naphtha, light cycle oil, heavy cycle oil, and even heavy oil. In one or more embodiments, a hydrocarbon product stream 102 comprising light olefins may be passed from the upper reaction zone 111 through hydrocarbon product outlet 112 in the upper reactor portion 110. In one or more embodiments, the hydrocarbon product stream 102 may comprise catalyst entrained within the hydrocarbon product stream 102 which may be separated from the hydrocarbon product stream 102 in a separation device. Any suitable separation device, including a cyclone or series of cyclones, may be used to separate entrained catalyst from the hydrocarbon product stream 102. In one or more embodiments, the light olefins may be separated from the hydrocarbon product stream 102. Separation of the light olefins from the hydrocarbon product stream may be achieved by any suitable means including, for example, distillation. In one or more embodiments, the separation of light olefins from the hydrocarbon product stream may result in relatively pure streams of ethylene, propylene, or butene.

In one or more embodiments, cracking the hydrocarbon feed stream 101 may produce spent catalyst. Spent catalyst may be produced in both the upper reaction zone 111 and the lower reaction zone 121. In one or more embodiments, spent catalyst may comprise coke on the catalyst. The coke may reduce the activity of the catalyst, and spent catalyst may have reduced activity when compared to regenerated or fresh catalyst. In one or more embodiments, the non-circulating fluidized bed of the lower reaction zone 121 may comprise spent catalyst. Without wishing to be bound by theory, the more reactive components of the hydrocarbon feed stream may crack in the lower reaction zone because high catalytic activity is not required for those components to react. As the hydrocarbon feed passes from the lower reaction zone 121 to the upper reaction zone 111, the hydrocarbon feed will encounter more active, fresh or regenerated catalyst, and the less reactive components of the hydrocarbon feed will crack. Thus, the counter-current flow of the catalyst and the hydrocarbon feed stream 101 may result in increased conversion of hydrocarbon feed to light olefins.

As used in this disclosure, the term “regenerated catalyst” refers to catalyst that has been introduced to a reaction zone and then regenerated in a regenerator to heat the catalyst to a greater temperature, oxidize and remove at least a portion of the coke from the catalyst to restore at least a portion of the catalytic activity of the catalyst, or both. The “regenerated catalyst” may have less coke, a greater temperature, or both compared to spent catalyst and may have greater catalytic activity compared to spent catalyst. The “regenerated catalyst” may have more coke and lesser catalytic activity compared to fresh catalyst that has not passed through a cracking reaction zone and regenerator.

As used in this disclosure, the term “spent catalyst” refers to catalyst that has been introduced to and passed through a reaction zone to crack a hydrocarbon feed, but has not been regenerated in the regenerator following introduction to the reaction zone. The “spent catalyst” may have coke deposited on the catalyst and may include partially coked catalyst as well as fully coked catalysts. The amount of coke deposited on the “spent catalyst” may be greater than the amount of coke remaining on the regenerated catalyst following regeneration.

In one or more embodiments, the reactor 100 may comprise a steam stripping portion 130 below the lower reactor portion 120. The steam stripping portion 130 may define a steam stripping zone 131. The steam stripping portion 130 may be in fluid communication with and adjacent to the lower reactor portion 120. In one or more embodiments, spent catalyst may pass from the lower reaction zone 121 to the steam stripping zone 131. In further embodiments, the spent catalyst may pass directly from the lower reaction zone 121 to the steam stripping zone 131. Steam may be passed to the steam stripping zone 131 by stream 105. In the steam stripping zone 131, steam may contact the spent catalyst and strip at least a portion of the hydrocarbon feed or hydrocarbon products from the spent catalyst. After contacting the steam in the steam stripping zone 131, spent catalyst may be passed in stream 104 from the reactor 100 through the catalyst outlet.

In one or more embodiments, the spent catalyst may be passed to a catalyst regenerator 150 where the spent catalyst is regenerated to form a regenerated catalyst. The catalyst regenerator 150 may comprise a riser 160 and a separator 170. The spent catalyst may enter the riser 160 through a catalyst inlet. In one or more embodiments, the riser 160 is in fluid communication with the steam stripping zone 131 of the reactor 100 and the spent catalyst may be passed directly from the steam stripping zone 131 to the riser 160. In one or more embodiments, an air stream 151 is passed to the riser 160, and the air and spent catalyst travel up riser 160. In one or more embodiments, the air stream 151 is used to oxidize at least a portion of the coke on the spent catalyst, restoring activity to the spent catalyst and forming a regenerated catalyst.

The regenerated catalyst and air may move from riser 160 to separator 170. In one or more embodiments, the riser 160 and separator 170 are adjacent to each other and the regenerated catalyst and air move directly from the riser 160 to the separator 170. Separator 170 may be any suitable separation system for separating catalyst from air, including a cyclone separation system. In one or more embodiments, an air stream 152 may exit the separator 170. Additionally, regenerated catalyst may exit the separator 170 through a regenerated catalyst outlet. In one or more embodiments, the regenerated catalyst may be included in the catalyst of stream 103. In one or more embodiments, the separator 170 and the upper reactor portion 110 may be in fluid communication with each other and regenerated catalyst may be passed directly from the separator 170 of the regenerator 150 to the upper reaction zone 111 of the reactor 100 through catalyst inlet 113. In one or more embodiments, fresh catalyst may be added to catalyst in stream 103. In such embodiments, the catalyst may comprise both regenerated catalyst and fresh catalyst.

Referring now to FIG. 2, which corresponds to FIG. 2 of U.S. Pat. No. 11,446,625, a fluidized catalytic cracking (FCC) system 200 system is depicted. The FCC system 200 includes a reactor/stripping/regenerator/condensation unit 202 (simply called herein the reaction unit) in which several reactions (to be discussed later) take place. The reaction unit 202 has a housing 204 that hosts the various zones. In one application, the housing 204 is a single housing that hosts all the zones to be discussed herein. At the bottom of the housing 204, there is a perforated (or porous) base plate 206 (also called a fluid bed distributor plate) that is configured to support a catalytic bed 210. The catalytic bed 210 originally includes catalyst particles 214 and no coke 212. The catalyst particles 214 may comprise any of the catalyst compositions described herein. In one application, the catalyst particles 214 includes one or more cracking catalysts in addition to the catalyst compositions described herein. The particles of the catalyst particles 214 may have a size distribution between 20 and 120 microns. In one embodiment, the catalyst particles 214 are placed into the feed and supplied into the reaction unit 202 from the feed. In other words, the catalyst particles 214 are either present in the unit or they are supplied with the feed or supplied separately from make-up tank containing fresh catalysts. After the reaction unit 202 is used for a certain time, coke 212 forms on the catalytic particles 214 and on the walls of the housing 204. The coke 212 is a fuel rich in carbon.

A fluidization gas 220 is provided at a bottom port 204B of the housing 204. The fluidization gas 220 may include water, or nitrogen, or a mixture of water and nitrogen, or other chemical elements that help to remove the coke, as discussed later. The fluidization gas 220 propagates through the porous base plate 206 and enters into the catalytic bed 210. Depending on the speed of the fluidization gas 220, the particles of coke and catalyst start moving around like into a fluid that is agitated, from which the name of the fluidization gas.

The housing 204 has also a top port 204A through which a product of the FCC process may be removed from the reaction unit 202, as discussed later. A feeding pipe 230 enters at the top part of the housing 204, and extends into the catalytic bed 210. One end 230A of the feeding pipe 230 is connected to a device 232 that is mixing the hydrocarbon feed stream 233 with liquid water 234 (if water is present, however, it is possible to introduce the hydrocarbon feed stream 233 with no water), and the other end 230B of the feeding pipe is placed inside the catalytic bed 210, i.e., in direct contact with the coke 212 and catalyst 214. The second end 230B of the feeding pipe may terminate with a spray nozzle 231. In one application, the height H of the second end 230B of the feeding pipe 230 relative to the base plate 206 is set to be smaller than the height h of the catalytic bed.

The catalytic bed 210 includes in the lower part not only the coke 212 and the catalyst 214, but also the inert fluidization gas and regeneration (reactive) gas 220. The inert fluidization gas cannot react with hydrocarbons or coke and remains chemically unchanged, but it may enhance desorption of strongly adsorbed hydrocarbons from the catalyst surface. The regeneration gas can react with coke and hydrocarbon and form gaseous products like CO and CO₂. This lower part is called herein the regeneration and stripping zone 240 for reasons to be discussed later. Preferably, the middle part of the catalytic bed 210 does not include any oxidating (regeneration) gas 220, but only the coke 212, inert fluidization gas and the catalyst 214, and this part is called the reaction zone 242. The molecules of the feedstock are added to the reaction zone. By being able to control a height H of the second end 230B of the feeding pipe 230 in the housing 204 (it should be high enough in the reaction zone 242), it is possible to control the volume of the stripping zone 241, which is located, as illustrated in FIG. 2, between the regeneration zone 240 and the reaction zone 242. Although FIG. 2 shows a narrow border 244 between the regeneration/stripping zone 241 and the reaction zone 242, one skilled in the art would understand that these border zones are not simple planes, but rather a volume in which the particles of the regeneration (reactive) gas 220 slowly disappear keeping only the inert fluidization gas and catalyst particles or feedstock molecules slowly disappears in product or unreactive adsorbed species. Further, a location of the border 244 relative to the base plate 206 depends on the height H of the second end 230B of the feeding pipe 230. In the regeneration zone 240, anything that did not desorb from the catalyst reacts when in contact with the regeneration (oxidizing) gas 220. A stripping zone 241 can be defined as a region of the reactor, usually located below the reaction zone 242 and above the regeneration zone 240, where the catalyst containing adsorbed non-reacted heavy hydrocarbons undergoes stripping under the action of an upwards flowing of inert fluidization gas to desorb these potentially “poisonous” molecules.

The reaction unit 202 described in FIG. 2 further includes a condensation zone 246, which, in one embodiment, extends from a top of the catalytic bed 210 to a top of the housing 204. The condensation zone 246 ideally does not include particles of coke or catalyst, although in practice, these particles find their way into the condensation zone. However, if the velocities in the condensation zone are reduced by increasing the reactor diameter, it is possible to dramatically reduce their presence in the condensation zone. In this zone, by controlling the temperature, only gases 250 that result from the FCC process travel from the catalytic bed to the top port 204A and are collected into a container 252. These gases, also called the reaction products, contain the desired petrochemicals. The reaction products in the condensation zone 246 preheats the cold feed inside the pipe and consequently, the heavier portions of the reaction product condenses and falls back to the reaction zone 242.

The system described in FIG. 2 may be used in various methods, further described herein. In embodiments, a method for processing hydrocarbons may include a step of supplying a hydrocarbon feed stream 236 to a reaction zone 242 located in a single reaction unit 202; a step of supplying a fluidization gas 220 to the reaction zone 242 through a regeneration zone 240 and a stripping zone 241, wherein the regeneration zone and the stripping zone are located in the single reaction unit 202; a step of converting the hydrocarbon feed stream 236 into a petrochemical fluid 250 (which may be a gas or liquid) in the reaction zone 242 in the presence of catalytic particles 214 (which may include any of the catalyst compositions described herein); and a step of condensing the petrochemical fluid 250 in the condensation zone 246 located in the single reaction unit 202.

In embodiments, the reaction zone 242 may be positioned between the condensation zone 246 and the regeneration/stripping zones 240/241. In the method, the hydrocarbon feed stream may be supplied along one or more feeding pipes to the reaction zone. In one application, the fluidization gas is supplied at a bottom port 204B, located at a bottom of the housing, to the regeneration/stripping zones. The petrochemical fluid may pass from the reaction zone into the condensation zone. The method may also include a step of heating up the hydrocarbon feed stream inside the pipe with the petrochemical fluid in the condensation zone. In one embodiment, the pipe extends through the condensation zone and the reaction zone. In another embodiment, the pipe extends through the regeneration zone and the reaction zone. In still another embodiment, the feeding pipe includes (1) a first pipe that extends through the condensation zone and the reaction zone, and (2) a second pipe that extends through the regeneration zone and the reaction zone. In one application, a volume of the condensation zone may be larger than a volume of the reaction zone. In yet another application, a volume of the reaction zone may be larger than a volume of the regeneration/stripping zones.

The FCC process that takes place inside the reaction unit 202 is further discussed herein. The method may comprise loading the catalytic bed 210 into the housing 204. As previously discussed, the catalytic bed 210 originally may include only the catalyst 214. The coke 212 may form during the cracking process on the catalyst particles. Part of the coke, called coke precursors, may be removed in the stripping zone 241 using the fluidization gas containing inert gases such as steam/Nitrogen. Coke precursors are defined as hydrocarbons adsorbed on the catalyst that can be desorbed at high temperatures in the presence of vacuum or a stripping inert gas. Hard coke can be removed in the presence of oxidizing fluidization gases. Hard coke is defined as those deposits that cannot be removed by stripping at temperatures in the range of 25° C. to 800° C. The used catalyst may contain additional functionalities apart from cracking (i.e., desulfurization, demetallation, aromatization, dealkylation, alkylation and/or de-nitrogenation).

In case of overheating of the catalytic bed 210, extra water or less O₂ may be fed to the reactor to reduce the temperature. Alternatively, as will be discussed with regard to other embodiments, it is possible to send more feedstock through the regeneration zone 240 and the stripping zone 241.

In the FCC process that takes place inside the reaction unit 202 the catalytic bed 210 may be fluidized by pumping the fluidization gas 220 through the base plate. The fluidization of the catalytic bed can be performed with a gas that contains oxidizing chemicals like O₂. However, two or more oxidants can also be mixed together. For example, O₂ can be mixed with other oxidants, like CO₂. The oxidants or mixture of oxidants should be able to convert the coke to CO₂ or CO and generate sufficient heat to keep the bed's temperature at a high desired value. Typical example might be O₂ in N₂ gas mixture (air or air diluted with N₂, H₂O, CO₂, flue gas, CO or oxygen diluted in H₂O, CO₂ or flue gas). Parameters which may control the efficiency of the process of generating the petrochemicals may include the concentration of the oxidant and the way the oxidant is applied. In embodiments, the concentration of the oxidant is selected to be in a range from 1 to 20 vol %. The concentration of the oxidant may be selected depending on the amount of hard coke to be burnt, but also on the fact that an explosive composition should be avoided within the reactor. This concentration is optimized together with the contact time in the regeneration and stripping zone. In embodiments, the oxidant can be supplied either in a continuous mode or in a periodic pulses. It is believed that the in-situ regeneration process of the catalyst using periodic pulses conditions may be the most efficient.

The method may further comprise supplying the feedstock 233 through the coil pipe 230 into the reaction unit 202. In embodiments, the feedstock 233 may be contacted with the water 234 in liquid from (not steam) and emulsified in the emulsifying device 232 (high shearing mixing device using, for example, ultrasound) to obtain well-dispersed oil droplets inside a continuous water phase. The temperature of the emulsion 236 can be in the range of 20° C. to the reaction's temperature while the pressure of the emulsion can be up to hundreds of bars. The pressure is used to keep the water in the liquid phase in the coil pipe 230. This emulsion 236 flows through the coil pipe 230 through the condensation zone 246, where it is evaporated by contact with the hot reaction products 250 and/or by sending it through the regeneration zone 240 and the stripping zone 241 of the vessel.

The distribution of the emulsion 236 over the catalyst particles 214 can be improved by using spray nozzles 231 or similar devices that generate a high amount of small emulsion droplets inside the catalytic bed 210. As discussed above, it is also possible to include the catalyst/makeup catalyst particles 214 into the emulsifying device 232, so that the catalysts particles are already mixed with the feedstock 233 when entering the reaction zone 242.

Having water 234 as the continuous phase in the feeding emulsion 236 further minimizes the loss of feedstock 233 in coke deposits on walls and lines of the system 200. Indeed, the present approach avoids direct contact between the hydrocarbon feed 233 and the walls 204. As the water 234 evaporation will take a lot of heat, overheating of the feedstock 233 before it enters the catalytic bed 210 may also prevented. Uncontrolled heating together with undesired thermal reactions are a source for coke deposits on walls and pipes in the traditional systems.

A ratio of the water 234 to the heavy hydrocarbon feed stream 233 is a controllable parameter that is ranging in this embodiment between 0.001 and 3 by weight. In one embodiment, water may be omitted. The water may be replaced by other energy enriched oxygenates such as methanol, aldehydes, ketones. Preferably, these oxygenates come from bio sources. Besides all of the benefits discussed above, these oxygenates, when cracked, add additional heat to fuel the hydrocarbon cracking and increase the yield of light olefins.

Depending on where the feedstock emulsion 236 and the oxidizing gas 220 are injected into the catalytic bed 210, and the amount of coke 212 produced on the catalyst, a part of the fluidized bed may be oxidant free. This part, as previously discussed, corresponds to the reaction zone 242, where the main part of the cracking and dehydrogenation reactions occur. The remaining part has still oxidizing gas present and thus, it allows burning of the coke 212 and generating heat to fuel the hydrocarbon cracking processes. This zone corresponds to the regeneration zone 240 and the stripping zone 241, as also discussed above.

There may be a gradient zone where both type of reactions are occurring and this zone corresponds to the border zone 244. An important parameter of the reactor unit is the volumetric ratio between the regeneration/stripping zone, the reaction zone, and the condensation zone. The ratio between the regeneration/stripping and reaction zones can range from 1 to 20, preferably 5-15, and most preferably should be around 10. This volumetric ratio is determined by the total height of the catalytic bed, the diameter of the vessel (housing) and the inlet's height of the feedstock. The size (e.g., volume) of the condensation zone can be changed depending upon the condensation temperature and the type of feedstock to be treated.

As described herein, the method may comprise condensating one or more effluent gases. The effluent gases obtained from the FCC process can be released into the condensation zone 246 for being condensed. The condensation can occur before the effluent gases 250 leave the reaction unit's housing 204. In this way, heavies 254 that are not completely converted/cracked are condensed and drop back to the catalytic bed 210, where they are re-cracked to more desired products. If not further cracked down, these condensed heavies 254 are a potential source for coke formation, which is partially needed for the heat generation process. This novel approach reduces or completely eliminates the need of external recycling streams and further downsizes the effluent purification units, downstream the reaction unit 202. Recycling of heavies may increase yield of desired products 250, and/or provide sufficient production of coke 212. The condensation zone 246 allows also efficient heat management. In one application, the condensed liquid may also reduce the coke soot that leave the reaction unit 202.

Regarding the temperature control and heat management for the FCC process within the reaction unit 200, a controller 260 and associated valves 262, 264, and 266 are employed to control the heat distribution. FIG. 2 shows fluidization valve 262, which controls the amount of fluidization gas 220 entering the housing 204. The feedstock valve 264 controls the amount of feedstock emulsion 236 that flows along the coil pipe 230 and effluent gas valve 266 controls the amount of effluent gas 250 that exits the housing 204. The controller 260 can independently control each of these valves as now discussed.

In embodiments, the temperature of the catalytic bed 210 may be from 400° C. to 1000° C. In embodiments, the temperature of the catalytic bed 210 may be from 500° C. to 850° C. The controller 260 has several ways to control the heat generated from the burning of the coke, and thus, the inside temperature of the housing. One of the main factors is the amount of carbon that is burned in the regeneration zone, which is measured by the yield of CO and CO₂ in the effluent gases, and which can be the main source for the heat required in the cracking process. The carbon to be combusted can be from heavy hydrocarbons, like asphaltenes, polyaromatics, etc. that are adsorbed onto the catalyst and are not cracked, or coke generated during the cracking process. In one application, the controller is programmed to minimize the use of hydrocarbon feed stream for heat generation. This use should be lower than 25 wt % of the feedstock, preferably even lower than 20 wt %, and ideally around 15 wt % or less. For instance, if the controller controls the reaction unit 202 to preheat the oil to 280° C. and the feedstock is cracked at 720° C., then 1100 kcal/kg feed is needed to reach these temperatures. It is estimated, based on literature data that around 150 g carbon per kg feedstock needs to be burned with oxygen to generate this heat. The chemical reaction is C+O2→CO2, with ΔH=−91 kcal/mol.

The controller may also be programmed to control other parameters for heat management. For example, the feedstock 233 and the oxidizing gas 220 may be preheated by leading them partially though the regeneration zone 240 and the stripping zone 241 or contacting them with the effluent gas 250 in the condensation zone 246 as illustrated in FIG. 2.

Alternatively, it is possible to lead the feedstock or oxidizing gas through a zone above the fluidized bed, where heavy parts are allowed to condense again by contact with the colder stream, thus recovering heat to preheat these streams. The condensed heavies 254 will drop back to the bed 210, where they can be further cracked.

Further example systems that may be utilized in the methods described above are depicted in FIGS. 2 and 4-8 of U.S. Pat. No. 11,446,625.

### EXAMPLES

The various embodiments of the catalyst compositions described will be further clarified by the following examples. The examples are illustrative in nature, and should not be to limit the subject matter of the present disclosure.

### Example 1—Catalyst Composition Preparation

A number of catalyst compositions were prepared with ZSM-5 zeolites having a different average crystallinity. The ZSM-5 zeolites were prepared as follows. A silica source gel (gel 1) was prepared by mixing sodium hydroxide (NaOH) pellets with deionized water in a sealed polypropylene container. The mixture was then stirred continuously until the NaOH pellets were completely dissolved. Colloidal silica (40 wt. % SiO₂ in H₂O, commercially available as LUDOX® AS-40 from Sigma Aldrich) was added to the solution and kept under stirring for at least 5 hours to form gel 1. An aluminum source gel (Gel 2) was prepared by mixing NaOH pellets and deionized water in a separate polypropylene container and stirred until fully dissolved. NaAlO₂ was added to the solution and stirred constantly for at least 5 hours to form Gel 2. Gel 1 and Gel 2 were combined in a sealed polypropylene container and vigorously stirred for 5 hours. The mixture was then transferred to a 125 mL Teflon-lined Parr Stainless Steel Autoclave and securely sealed. The mixture was then placed in a preheated rotation oven at 160° C. for a duration of either 20, 25, 27, 30, or 39 hours to crystallize the material. After the set crystallization time, the autoclave was removed from the oven and cooled rapidly under a stream of cold tap water. The solid product was collected by centrifugation and decantation and washed thoroughly with deionized water during the decantation steps. Drying and weighing of the ZSM-5 product was then carried out. The product was ion-exchanged in a solution of 1 M NH₄NO₃ for 3 hours and repeated for 3 times to produce NH₄-ZSM-5. The H-form of the zeolite (H-ZSM-5) was obtained by calcining the NH₄-ZSM-5 at 550° C. for 5 hours.

The ZSM-5 produced with varying crystallization time (20, 25, 27, 30, or 39 hours) was further characterized. Powder X-ray diffraction (XRD) and temperature-programmed desorption of NH₃ (NH₃-TPD) were used to investigate how crystallization time affected the structure of the ZSM-5 zeolite. XRD was performed after hydrothermal treatment and sample recovery including washing and drying and before ion exchange. The NH₃-TPD data was obtained after ion exchange and further calcination to obtain the active H-form of the zeolite.

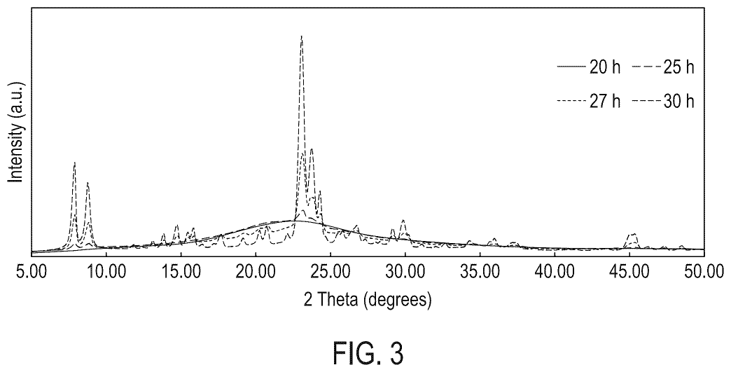

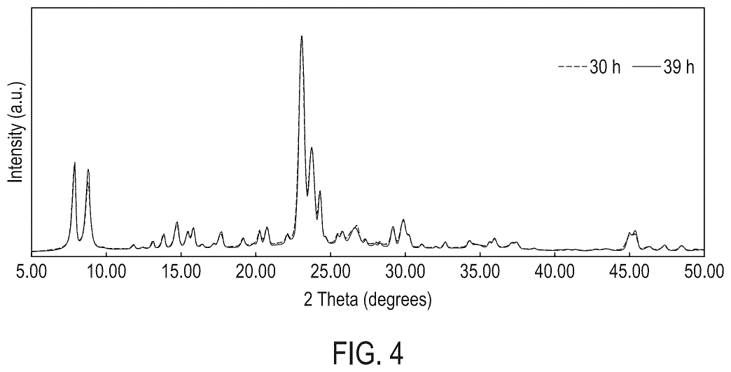

The powder XRD data are shown in FIG. 3 with relative intensity on the y-axis as a function of 2 theta in degrees on the x-axis for the ZSM-5 zeolites formed using a crystallization time of 20, 25, 27, or 30 hours corresponding to zeolite A, B, C, and D, respectively. FIG. 3 shows that at 20 hours (A), a completely amorphous structure is observed with a single broad peak in the XRD pattern. As the crystallization time increases, characteristic peaks of the MFI structure observed and completed at 30 hours (D). FIG. 4 depicts the XRD data for the ZSM-5 zeolites formed using a crystallization time of 30 hours or 39 hours corresponding to zeolite D and E, respectively. As shown in FIG. 4, further increasing the crystallization time from 30 hours to 39 hours did not result in any further change in the XRD plot, suggesting that crystallization is completed after 30 hours. The average crystallinity of zeolites A, B, and C, were calculated by comparing the relative peak height normalized to the peak of zeolite D using the methods described herein and are reported in Table 1.

TABLE 1

| | Crystallization | Average |
|---|---|---|
| Zeolite | Time (hr) | Crystallinity (%) |
| A | 20 | 0 |
| B | 25 | 9.1 |
| C | 27 | 42.6 |
| D | 30 | 100 |

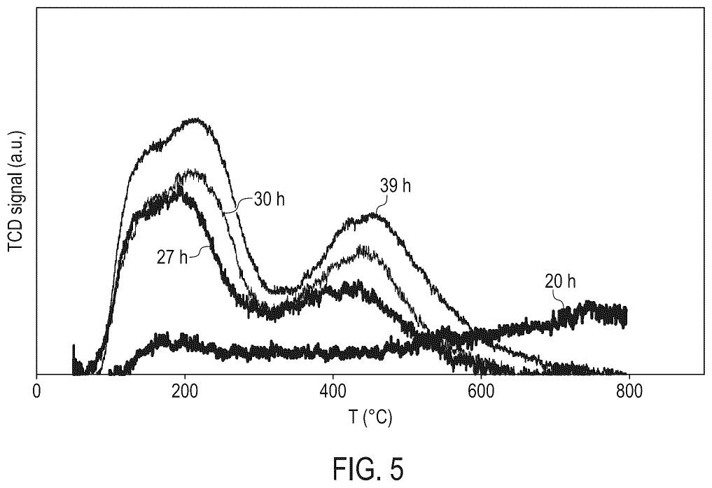

FIG. 5 depicts the NH₃-TPD spectra of zeolites A, B, C, and D. As shown in FIG. 5, increased crystallization time resulted in more well-defined crystals leading to higher proportion of strong acid sites while shorter crystallization time created defects in the zeolite framework.

Catalyst compositions comprising the H-ZSM-5 (A, B, C, or D) were prepared, corresponding to Catalyst Compositions 1, 2, 3, and 4, respectively. In particular, Pural SB grade alumina was mixed with distilled water to form an alumina binder slurry. Kaolin clay was added to the alumina binder slurry and stirred for 5 minutes, followed by the addition of the H-ZSM-5 and stirring, followed by the addition of colloidal silica (40 wt. % SiO₂ in H₂O, commercially available as LUDOX® AS-40 from Sigma Aldrich) and stirring. The mixture was stirred for 25 minutes at room temperature and was then heated to approximately 50° C.-60° C. for 2-3 hours until a solid cake formed. The material was dried overnight at a temperature of 80° C. to 100° C. After drying, the material was calcined according to the following program: increase the temperature from room temperature to 125° C. at a rate of 3° C. per minute, hold the temperature at 125° C. for 30 minutes, increase the temperature from 125° C. to 250° C. at a rate of 4° C. per minute, hold the temperature at 250° C. for 60 minutes, increase the temperature from 250° C. to 550° C. at a rate of 2° C. per minute, and hold the temperature at 550° C. for 90 minutes. After calcination, the catalyst was sieved and the fraction between 50-100 microns was collected for further testing. The compositions of the catalyst compositions were recorded in Table 2.

TABLE 2

| | | | | | Binder, wt. % | | |
|---|---|---|---|---|---|---|---|
| | | | | | | | Kaolin |
| Catalyst | Zeolites wt. % | | | | | Ludox | Clay |
| Composition | A | B | C | D | Al₂Cl(OH)₅ | AS-40 | wt. % |
| 1 | 40 | — | — | — | 15 | 10 | 35 |
| 2 | — | 40 | — | — | 15 | 10 | 35 |
| 3 | — | — | 40 | — | 15 | 10 | 35 |
| 4 | — | — | — | 40 | 15 | 10 | 35 |

### Example 2—Catalytic Testing

Catalytic performance testing of the Catalyst Compositions 1-4 was carried out in a riser simulator reactor, which is a bench-scale internal recycle batch reactor. The feedstock used in the reaction was n-hexane and all experiments were performed at 500° C., a 7.6 catalyst to oil ratio, and 5 seconds contact time. The resulting conversion %, and paraffin/olefin molar ratio using the catalyst compositions are reported in Table 3.

TABLE 3

| Catalyst | ZSM-5 | | Paraffins/Olefins |
|---|---|---|---|
| Composition | crystallinity | Conversion % | (Molar ratio) |
| 1 | 0% | 0.69 | 1.69 |
| 2 | 9.1% | 4.22 | 1.23 |
| 3 | 42.6% | 11.57 | 1.92 |
| 4 | 100% | 7.31 | 2.91 |

As shown in Table 3, the catalyst composition comprising ZSM-5 having an average crystallinity of 42.6% resulted in enhanced conversion of n-hexane to light olefins (Catalyst 3) compared to the catalyst compositions comprising ZSM-5 having no crystallinity (Catalyst 1), complete crystallinity (Catalyst 4), or a further reduced crystallinity of 9.1% (Catalyst 2). Overall, the Examples indicate that by selecting a zeolite comprising a first portion of zeolite having a 10-membered pore ring structure having a reduced average crystallinity (e.g., greater than or equal to 30% and less than or equal to 60%), one can improve overall conversion of the reaction without sacrificing selectivity towards a target product or products.

The present disclosure includes numerous aspects. A first aspect is a method for processing hydrocarbons, the method comprising: passing a hydrocarbon feed stream into a feed inlet of a reactor, wherein the reactor comprises: an upper reactor portion defining an upper reaction zone, the upper reactor portion comprising a catalyst inlet and a hydrocarbon product outlet, wherein the catalyst inlet and the hydrocarbon product outlet are positioned at or near the top of the upper reactor portion; and a lower reactor portion defining a lower reaction zone, the lower reactor portion comprising a feed inlet and a catalyst outlet, wherein feed inlet and the catalyst outlet are positioned at or near the bottom of the lower reactor portion, and wherein the lower reaction zone is in fluid communication with and adjacent to the upper reaction zone; and wherein:a catalyst composition moves in a generally downward direction through the upper reactor portion and the lower reactor portion and the hydrocarbon feed stream moves in a generally upward direction through the upper reactor portion and lower reactor portion such that the hydrocarbon feed stream and the catalyst composition move with a counter-current orientation; the upper reaction zone operates with a counter-current plug flow regime; the lower reaction zone operates with a dense bed fluidization regime; contacting the catalyst composition with the hydrocarbon feed stream cracks one or more components of the hydrocarbon feed stream and forms a hydrocarbon product stream, wherein the hydrocarbon product stream comprises one or more of ethylene, propylene, or butene; and the catalyst composition comprises a zeolite comprising a first portion of zeolite having a 10-membered ring pore structure, wherein the first portion of zeolite has an average crystallinity of greater than or equal to 30% and less than or equal to 90%; and passing the hydrocarbon product stream out of the upper reaction zone through the hydrocarbon product outlet.

Another aspect is any previous aspect or combination of previous aspects, wherein a superficial velocity of the hydrocarbon feed stream through the upper reaction zone is 3.0 m/s or less.

Another aspect is any previous aspect or combination of previous aspects, further comprising: passing the catalyst through the catalyst outlet to a catalyst regenerator, wherein the catalyst passing through the catalyst outlet is spent catalyst; regenerating at least a portion of the spent catalyst to form a regenerated catalyst; and passing the regenerated catalyst to the upper reaction zone through the catalyst inlet.

Another aspect is any previous aspect or combination of previous aspects, further comprising passing the catalyst through the catalyst outlet to a steam stripping portion of the reactor.

Another aspect is any previous aspect or combination of previous aspects, wherein, in the steam stripping portion, steam contacts the catalyst and at least a portion of hydrocarbon feed or at least a portion of hydrocarbon product are stripped from the catalyst.

Another aspect is any previous aspect or combination of previous aspects, wherein the catalyst composition comprises: from 10 wt. % to 75 wt. % of binder; and from 5 wt. % to 70 wt. % of the zeolite.

Another aspect is any previous aspect or combination of previous aspects, wherein the zeolite further comprises a second portion of zeolite having a 12-membered ring pore structure, wherein the second portion of zeolite has an average crystallinity of greater than or equal to 90%.

Another aspect is any previous aspect or combination of previous aspects, wherein the second portion of zeolite comprises zeolite Y.

Another aspect is any previous aspect or combination of previous aspects, wherein the zeolite comprises from 10 wt. % to 90 wt. % of the first portion of zeolite and from 10 wt. % to 90 wt. % of the second portion of zeolite.

Another aspect is any previous aspect or combination of previous aspects, wherein the first portion of zeolite comprises ZSM-5 zeolite.

Another aspect is any previous aspect or combination of previous aspects, wherein the first portion of zeolite has an average crystallinity of greater than or equal to 30% and less than or equal to 60%.

Another aspect is any previous aspect or combination of previous aspects, wherein the hydrocarbon feed stream comprises crude oil.

Another aspect is any previous aspect or combination of previous aspects, wherein the hydrocarbon feed stream has an initial boiling point of at least 25° C.

Another aspect is any previous aspect or combination of previous aspects, wherein the hydrocarbon feed stream comprises one or more of C₄ components, light naphtha, heavy naphtha, full range naphtha, vacuum gas oil, crude oil, FCC gasoline, olefinic naphtha, atmospheric residue, vacuum residue, condensate, deasphalted crude oil, dewaxed crude oil, deasphated-dewaxed crude oil, kerosene, or diesel.

Another aspect is any previous aspect or combination of previous aspects, wherein a weight hourly space velocity of the lower reaction zone is from 1 to 200 hr¹.

Another aspect is any previous aspect or combination of previous aspects, wherein a catalyst to oil ratio in the upper reaction zone is from 5 to 100.

Another aspect is any previous aspect or combination of previous aspects, wherein a residence time of the hydrocarbon feed stream within the reactor is from 0.1 to 10 seconds.

Another aspect is any previous aspect or combination of previous aspects, wherein a temperature within the reactor is from 420° C. to 750° C.

Another aspect is any previous aspect or combination of previous aspects, further comprising passing the catalyst through the catalyst outlet to a steam stripping portion of the reactor.

Another aspect is any previous aspect or combination of previous aspects, wherein, in the steam stripping portion, steam contacts the catalyst and at least a portion of hydrocarbon feed or at least a portion of hydrocarbon product are stripped from the catalyst.

Another aspect is a method for processing hydrocarbons, the method comprising: supplying a hydrocarbon feed stream to a reaction zone located in a single reaction unit; supplying a fluidization gas to the reaction zone through a regeneration zone and a stripping zone, wherein the regeneration zone and the stripping zone are located in the single reaction unit; converting the hydrocarbon feed stream into a petrochemical fluid in the reaction zone in the presence of a catalyst composition; and condensing the petrochemical fluid in a condensation zone located in the single reaction unit; wherein: the reaction zone is positioned between the condensation zone and the regeneration and stripping zones; each of the regeneration zone, the stripping zone, the reaction zone, and the condensation zone is located within the single reaction unit so that each zone is in direct contact with at least another zone within the single reaction unit; and the catalyst composition comprises a zeolite comprising a first portion of zeolite having a 10-membered ring pore structure, wherein the first portion of zeolite has an average crystallinity of greater than or equal to 30% and less than or equal to 90%.

Another aspect is any previous aspect or combination of previous aspects, wherein the single reaction unit operates with a reaction temperature from 400° C. to 1000° C., a regeneration temperature from 500° C. to 1000° C., a feed stream residence time from 0.05 s to 100 s, and a pressure from 0.1 to 30 bar.

Another aspect is any previous aspect or combination of previous aspects, wherein the catalyst composition comprises: from 10 wt. % to 75 wt. % of binder; and from 5 wt. % to 70 wt. % of the zeolite.

Another aspect is any previous aspect or combination of previous aspects, wherein the zeolite further comprises a second portion of zeolite having a 12-membered ring pore structure, wherein the second portion of zeolite has an average crystallinity of greater than or equal to 90%.

Another aspect is any previous aspect or combination of previous aspects, wherein the second portion of zeolite comprises zeolite Y.

Another aspect is any previous aspect or combination of previous aspects, wherein the first portion of zeolite comprises ZSM-5 zeolite.

Another aspect is any previous aspect or combination of previous aspects, wherein the first portion of zeolite has an average crystallinity of greater than or equal to 30% and less than or equal to 60%.

Another aspect is any previous aspect or combination of previous aspects, wherein the hydrocarbon feed stream comprises crude oil.

Another aspect is any previous aspect or combination of previous aspects, wherein the hydrocarbon feedstock is supplied along a pipe to the reaction zone.

Another aspect is any previous aspect or combination of previous aspects, wherein the fluidization gas is supplied at a bottom port, located at a bottom of the housing, to the regeneration zone.

Another aspect is any previous aspect or combination of previous aspects, wherein the petrochemical fluid passes from the reaction zone into the condensation zone.

Another aspect is any previous aspect or combination of previous aspects, further comprising: heating up the hydrocarbon feedstock inside the pipe with the petrochemical fluid in the condensation zone.

Another aspect is any previous aspect or combination of previous aspects, wherein the pipe extends through the condensation zone and the reaction zone.

Another aspect is any previous aspect or combination of previous aspects, wherein the pipe extends through the regeneration/stripping zone and the reaction zone.

Another aspect is any previous aspect or combination of previous aspects, wherein the feeding pipe includes (1) a first pipe that extends through the condensation zone and the reaction zone, and (2) a second pipe that extends through the regeneration/stripping zone and the reaction zone.

Another aspect is any previous aspect or combination of previous aspects, wherein a volume of the condensation zone is larger than a volume of the reaction zone.

Another aspect is any previous aspect or combination of previous aspects, wherein a volume of the reaction zone is larger than a volume of the regeneration/stripping zone.

Another aspect is any previous aspect or combination of previous aspects, wherein the catalytic particles are supplied with the hydrocarbon feedstock.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter.

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

What is claimed is:

1. A method for processing hydrocarbons, the method comprising:
passing a hydrocarbon feed stream into a feed inlet of a reactor, wherein the reactor comprises:
an upper reactor portion defining an upper reaction zone, the upper reactor portion comprising a catalyst inlet and a hydrocarbon product outlet, wherein the catalyst inlet and the hydrocarbon product outlet are positioned at or near the top of the upper reactor portion; and
a lower reactor portion defining a lower reaction zone, the lower reactor portion comprising a feed inlet and a catalyst outlet, wherein feed inlet and the catalyst outlet are positioned at or near the bottom of the lower reactor portion, and wherein the lower reaction zone is in fluid communication with and adjacent to the upper reaction zone; and
wherein:
a catalyst composition moves in a generally downward direction through the upper reactor portion and the lower reactor portion and the hydrocarbon feed stream moves in a generally upward direction through the upper reactor portion and lower reactor portion such that the hydrocarbon feed stream and the catalyst composition move with a counter-current orientation;
the upper reaction zone operates with a counter-current plug flow regime;
the lower reaction zone operates with a dense bed fluidization regime;
contacting the catalyst composition with the hydrocarbon feed stream cracks one or more components of the hydrocarbon feed stream and forms a hydrocarbon product stream, wherein the hydrocarbon product stream comprises one or more of ethylene, propylene, or butene; and
the catalyst composition comprises a zeolite comprising a first portion of zeolite having a 10-membered ring pore structure, wherein the first portion of zeolite has an average crystallinity of greater than or equal to 30% and less than or equal to 90%; and
passing the hydrocarbon product stream out of the upper reaction zone through the hydrocarbon product outlet.

2. The method of claim 1, wherein a superficial velocity of the hydrocarbon feed stream through the upper reaction zone is 3.0 m/s or less.

3. The method of claim 1, further comprising:
passing the catalyst through the catalyst outlet to a catalyst regenerator, wherein the catalyst passing through the catalyst outlet is spent catalyst;
regenerating at least a portion of the spent catalyst to form a regenerated catalyst; and
passing the regenerated catalyst to the upper reaction zone through the catalyst inlet.

4. The method of claim 1, further comprising passing the catalyst through the catalyst outlet to a steam stripping portion of the reactor.

5. The method of claim 4, wherein, in the steam stripping portion, steam contacts the catalyst and at least a portion of hydrocarbon feed or at least a portion of hydrocarbon product are stripped from the catalyst.

6. The method of claim 1, wherein the catalyst composition comprises:
from 10 wt. % to 75 wt. % of binder; and
from 5 wt. % to 70 wt. % of the zeolite.

7. The method of claim 1, wherein the zeolite further comprises a second portion of zeolite having a 12-membered ring pore structure, wherein the second portion of zeolite has an average crystallinity of greater than or equal to 90%.

8. The catalyst composition of claim 7, wherein the second portion of zeolite comprises zeolite Y.

9. The catalyst composition of claim 7, wherein the zeolite comprises from 10 wt. % to 90 wt. % of the first portion of zeolite and from 10 wt. % to 90 wt. % of the second portion of zeolite.

10. The catalyst composition of claim 1, wherein the first portion of zeolite comprises ZSM-5 zeolite.

11. The method of claim 1, wherein the first portion of zeolite has an average crystallinity of greater than or equal to 30% and less than or equal to 60%.

12. The method of claim 1, wherein the hydrocarbon feed stream comprises crude oil.

13. A method for processing hydrocarbons, the method comprising:
supplying a hydrocarbon feed stream to a reaction zone located in a single reaction unit;
supplying a fluidization gas to the reaction zone through a regeneration zone and a stripping zone, wherein the regeneration zone and the stripping zone are located in the single reaction unit;
converting the hydrocarbon feed stream into a petrochemical fluid in the reaction zone in the presence of a catalyst composition; and
condensing the petrochemical fluid in a condensation zone located in the single reaction unit;
wherein:
the reaction zone is positioned between the condensation zone and the regeneration and stripping zones;
each of the regeneration zone, the stripping zone, the reaction zone, and the condensation zone is located within the single reaction unit so that each zone is in direct contact with at least another zone within the single reaction unit; and
the catalyst composition comprises a zeolite comprising a first portion of zeolite having a 10-membered ring pore structure, wherein the first portion of zeolite has an average crystallinity of greater than or equal to 30% and less than or equal to 90%.

14. The method of claim 13, wherein the single reaction unit operates with a reaction temperature from 400° C. to 1000° C., a regeneration temperature from 500° C. to 1000° C., a feed stream residence time from 0.05 s to 100 s, and a pressure from 0.1 to 30 bar.

15. The method of claim 13, wherein the catalyst composition comprises:
from 10 wt. % to 75 wt. % of binder; and
from 5 wt. % to 70 wt. % of the zeolite.

16. The method of claim 13, wherein the zeolite further comprises a second portion of zeolite having a 12-membered ring pore structure, wherein the second portion of zeolite has an average crystallinity of greater than or equal to 90%.

17. The catalyst composition of claim 16, wherein the second portion of zeolite comprises zeolite Y.

18. The catalyst composition of claim 13, wherein the first portion of zeolite comprises ZSM-5 zeolite.

19. The method of claim 13, wherein the first portion of zeolite has an average crystallinity of greater than or equal to 30% and less than or equal to 60%.

20. The method of claim 13, wherein the hydrocarbon feed stream comprises crude oil.
